(19) United States
(12) Patent Application Publication
(10) Pub. No.: US 2016/0379538 A1
(43) Pub. Date: Dec. 29, 2016

(54) METHOD AND APPARATUS FOR TRANSMITTING DATA AND DISPLAY APPARATUS

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventor: Long Yan, Beijing (CN)

(21) Appl. No.: 15/085,728

(22) Filed: Mar. 30, 2016

(30) Foreign Application Priority Data
Jun. 26, 2015 (CN) 201510369166.5

(51) Int. Cl. G09G 3/20

(52) U.S. Cl. CPC G09G 3/20; G09G 2340/04; G09G 2330/021

(57) ABSTRACT

The present disclosure provides a method and apparatus for transmitting data, and a display apparatus, to reduce an amount of data in the process of data transmission without influencing normal display of an image, thereby reducing power consumption required in the process of data transmission and saving resources. The method for transmitting data comprises: determining an amount of data of an image transmitted by a signal source; determining a transmission mode corresponding to the amount of data of the image according to a predetermined condition; and determining mode selection information for indicating a timing controller to select different operation modes according to the transmission mode corresponding to the amount of data, and transmitting the mode selection information to the timing controller.

### CROSS-REFERENCE TO RELATED APPLICATION(S)

This application claims priority to the Chinese Patent Application No. 201510369166.5, filed on Jun. 26, 2015, entitled “METHOD AND APPARATUS FOR TRANSMITTING DATA AND DISPLAY APPARATUS” which is incorporated herein by reference in its entirety.

### TECHNICAL FIELD

The present disclosure relates to the technical field of display, and more particularly, to a method and apparatus for transmitting data, and a display apparatus.

### BACKGROUND

With the development of display technology, power consumption is always a key index for design of display products. For the purpose of reducing logic power consumption, many methods have been researched to reduce the power consumption in the process of data transmission.

In a first method according to the related art, a Panel Self Refresh (PSR) technology of a display apparatus is incorporated into a Display Port (DP) of a display device, and a Remote Frame Buffer (RFB) is added at the display apparatus side to store a signal source which is input externally therein. For example, when content of a next frame signal can be obtained by only rewriting a part of content of a current frame signal, content stored in the RFB is directly modified with the part required to be rewritten. For example, as shown in FIG. 1, during data transmission, if a system module determines that data to be transmitted in a next frame is changed, only a part of the data required to be changed is transmitted to a timing controller, and then content stored in a RFB in the timing controller is directly modified with the part required to be changed. In this way, when a small amount of data changes, the power consumption required in the process of data transmission can be reduced.

However, the above method merely considers the data which is transmitted repeatedly with a change, and the content in the buffer is modified so as to reduce the power consumption in the process of data transmission. But the above method does not consider a relationship between an amount of data of an input signal and an amount of data of the display apparatus per se. If an amount of data of an image transmitted by a signal source is less than an amount of data in the display apparatus, a condition of wasting resources or the like may occur.

In a second method according to the related art, in general, after receiving an input signal transmitted by a signal source, a system module converts the input signal into an amount of data of an image, wherein the amount of data of the image comprises a resolution and the number of color bits of the image, and the resolution of the image comprises the number of row pixels and the number of column pixels. For example, assuming that A is used to represent the number of row pixels of an image of a signal source, B is used to represent the number of column pixels of the image of the signal source, and C is used to represent the number of color bits of the image of the signal source, an amount of data of the signal source is A*B*C. Assuming that D is used to represent the number of row pixels of an image of a display apparatus, E is used to represent the number of column pixels of the image of the display apparatus, and F is used to represent the number of color bits of the image of the display apparatus, a maximum amount of data of the display apparatus is D*E*F. In general, a signal scaling/processing module in the system module converts the amount of data A*B*C of the signal source into the maximum amount of data D*E*F of the display apparatus, and then transmits the amount of data D*E*F to the timing controller. The timing controller controls the display apparatus to normally display. Thus, when A*B*C<D*E*F, the system module transmits the amount of data D*E*F to the timing controller, thereby increasing the power consumption required for transmitting the amount of data. Therefore, in order to reduce the power consumption required for the amount of data output by the system module, improvements are made to the second method. Specifically, as shown in FIG. 2, the signal scaling/processing module is transferred into the timing controller so that when the system module transmits data to the timing controller, the system module directly transmits the amount of data of the signal source to the timing controller, and then the timing controller converts the amount of data A*B*C of the signal source into the maximum amount of data D*E*F of the display apparatus, thereby reducing the power consumption required in the process of data transmission between the system module and the timing controller in a case of A*B*C<D*E*F.

Thus, with the second method, the power consumption required in the process of data transmission between the system module and the timing controller is reduced, but the power consumption required in the process of data transmission between the timing controller and the display apparatus is not changed.

In conclusion, in the related art, in a case that the amount of data of the image of the signal source is less than the amount of data of the display apparatus, the amount of data in the process of data transmission cannot be reduced, thereby increasing the power consumption required in the process of data transmission.

### SUMMARY

Embodiments of the present disclosure provide a method and apparatus for transmitting data, and a display apparatus, to reduce an amount of data in the process of data transmission without influencing normal display of an image, thereby reducing power consumption required in the process of data transmission and saving resources.

The embodiments of the present disclosure provide a method for transmitting data, comprising:

determining an amount of data of an image transmitted by a signal source;

determining a transmission mode corresponding to the amount of data of the image according to a predetermined condition; and

determining mode selection information for indicating a timing controller to select different operation modes according to the transmission mode corresponding to the amount of data, and transmitting the mode selection information to the timing controller.

With the method for transmitting data according to the embodiments of the present disclosure, the system module firstly determines an amount of data of an image transmitted by a signal source; then determines a transmission mode corresponding to the amount of data of the image according to a predetermined condition; and finally determines mode selection information for indicating a timing controller to select different operation modes according to the transmission mode corresponding to the amount of data, and transmits the mode selection information to the timing controller. That is, in the embodiments of the present disclosure, the mode selection information for indicating the timing controller to select different operation modes is determined according to the amount of data of the image. Therefore, without influencing normal display of an image, when the amount of data of the image is small, the amount of data included in the corresponding mode selection information is also small, thereby reducing the amount of data in the process of data transmission between the system module and the timing controller as well as the power consumption required in the process of data transmission, and saving resources.

Preferably, determining a transmission mode corresponding to the amount of data of the image according to a predetermined condition comprises:

when the number of row pixels of a resolution of the image is less than or equal to a half of the number of row pixels of a resolution of a display apparatus and the number of column pixels of the resolution of the image is less than or equal to a half of the number of column pixels of the resolution of the display apparatus, determining that the transmission mode corresponding to the amount of data of the image is a low-speed transmission mode; and

when the number of row pixels of the resolution of the image is greater than a half of the number of row pixels of the resolution of the display apparatus and the number of column pixels of the resolution of the image is greater than a half of the number of column pixels of the resolution of the display apparatus, determining that the transmission mode corresponding to the amount of data of the image is a high-speed transmission mode;

wherein power consumption required for transmitting the mode selection information in the low-speed transmission mode is less than power consumption required for transmitting the mode selection information in the high-speed transmission mode.

When it is determined that the transmission mode corresponding to the amount of data of the image is a low-speed transmission mode according to the predetermined condition, mode selection information corresponding to the low-speed transmission mode is determined, thereby reducing the power consumption required for data transmission between the system module and the timing controller through the mode selection information corresponding to the low-speed transmission mode in the process of the data transmission.

Preferably, the mode selection information comprises mode conversion information for indicating the timing controller to select an operation mode and a resolution required to be used by the display apparatus for displaying an image corresponding to the operation mode used by the timing controller.

Preferably, determining the mode selection information according to the transmission mode corresponding to the amount of data comprises:

when the transmission mode corresponding to the amount of data is the low-speed transmission mode, determining the low-speed transmission mode and a half of the highest resolution of the display apparatus as the mode selection information; and

when the transmission mode corresponding to the amount of data is the high-speed transmission mode, determining the high-speed transmission mode and the highest resolution of the display apparatus as the mode selection information.

Since a resolution corresponding to the low-speed transmission mode is small, an amount of data included in the mode selection information corresponding to the low-speed transmission mode is small, thereby reducing the power consumption required for transmitting the mode selection information and saving resources.

Preferably, transmitting the mode selection information to the timing controller comprises:

transmitting the mode selection information to the timing controller through an auxiliary data channel.

The mode selection information is transmitted to the timing controller through the auxiliary data channel without adding additional wiring for transmitting the mode selection information.

The embodiments of the present disclosure provide a method for transmitting data, comprising:

receiving mode selection information transmitted by a system module, wherein the mode selection information is indication information for indicating a timing controller to select different operation modes which is determined by the system module according to a transmission mode corresponding to an amount of data of an image; and

determining the operation mode of the timing controller according to the mode selection information and transmitting a driving signal corresponding to the operation mode of the timing controller to a display apparatus.

With the method for transmitting data according to the embodiments of the present disclosure, the timing controller firstly receives mode selection information transmitted by a system module; and then determines an operation mode of the timing controller according to the mode selection information and transmits a driving signal corresponding to the operation mode of the timing controller to a display apparatus. That is, in the embodiments of the present disclosure, the mode selection information for indicating the timing controller to select different operation modes is determined according to the amount of data of the image. Therefore, without influencing normal display of an image, when the amount of data of the image is small, the amount of data included in the corresponding mode selection information and thus a frequency of a driving signal corresponding to the amount of data are also small, thereby reducing the frequency of the driving signal in the process of data transmission between the timing controller and the display apparatus as well as the power consumption required in the process of data transmission, and saving resources.

Preferably, the mode selection information comprises mode conversion information for indicating the timing controller to select an operation mode and a resolution required to be used by the display apparatus for displaying an image corresponding to the operation mode used by the timing controller.

Preferably, determining the operation mode of the timing controller according to the mode selection information and transmitting a driving signal corresponding to the operation mode of the timing controller to a display apparatus comprises:

determining that the operation mode of the timing controller is a low-speed transmission mode according to the mode conversion information in the mode selection information being the low-speed transmission mode, determining a driving frequency of a driver of the timing controller for driving row pixels in the low-speed transmission mode according to the number of row pixels of the resolution in the mode selection information and transmitting the driving frequency of the driver for driving row pixels to the display apparatus; and determining a driving frequency of a driver of the timing controller for driving column pixels in the low-speed transmission mode according to the number of column pixels of the resolution in the mode selection information and transmitting the driving frequency of the driver for driving column pixels to the display apparatus; or

determining that the operation mode of the timing controller is a high-speed transmission mode according to the mode conversion information in the mode selection information being the high-speed transmission mode, determining a driving frequency of the driver of the timing controller for driving row pixels in the high-speed transmission mode according to the number of row pixels of the resolution in the mode selection information and transmitting the driving frequency of the driver for driving row pixels to the display apparatus; and determining a driving frequency of the driver of the timing controller for driving column pixels in the high-speed transmission mode according to the number of column pixels of the resolution in the mode selection information and transmitting the driving frequency of the driver for driving column pixels to the display apparatus;

wherein power consumption required for transmitting the driving frequency in the low-speed transmission mode is less than power consumption required for transmitting the driving frequency in the high-speed transmission mode.

In the data transmission between the timing controller and the display apparatus, the power consumption required in the process of transmitting the driving signal determined in the low-speed transmission mode is less than the power consumption required in the process of transmitting the driving signal determined in the high-speed transmission mode.

Preferably, the method further comprises:

when it is determined that the operation mode of the timing controller is the low-speed transmission mode, transmitting a control signal for indicating a first switch unit and a second switch unit of the display apparatus to switch on to the display apparatus; and

when it is determined that the operation mode of the timing controller is the high-speed transmission mode, transmitting a control signal for indicating the first switch unit and the second switch unit of the display apparatus to be switched off to the display apparatus;

wherein the first switch unit is configured to control whether to conduct a group of gate lines comprised of two adjacent rows of gate lines, and different groups of gate lines comprise different gate lines; and the second switching unit is configured to control whether to conduct a group of data lines comprised of two adjacent columns of data lines, and different groups of data lines comprise different data lines.

The display apparatus is controlled by the control signal transmitted by the timing controller in a low-speed transmission mode, thereby reducing the power consumption required by the display apparatus for displaying an image.

The embodiments of the present disclosure provide an apparatus for transmitting data, comprising:

a determination module configured to determine an amount of data of an image transmitted by a signal source;

a mode selection module configured to determine a transmission mode corresponding to the amount of data of the image according to a predetermined condition; and

a mode selection information module configured to determine mode selection information for indicating a timing controller to select different operation modes according to the transmission mode corresponding to the amount of data, and transmit the mode selection information to the timing controller.

With the apparatus for transmitting data according to the embodiments of the present disclosure, the system module firstly determines an amount of data of an image transmitted by a signal source; then determines a transmission mode corresponding to the amount of data of the image according to a predetermined condition; and finally determines mode selection information for indicating a timing controller to select different operation modes according to the transmission mode corresponding to the amount of data, and transmits the mode selection information to the timing controller. That is, in the embodiments of the present disclosure, the mode selection information for indicating the timing controller to select different operation modes is determined according to the amount of data of the image. Therefore, without influencing normal display of an image, when the amount of data of the image is small, the amount of data included in the corresponding mode selection information is also small, thereby reducing the amount of data in the process of data transmission between the system module and the timing controller as well as the power consumption required in the process of data transmission, and saving resources.

Preferably, the mode selection module is further configured to:

when the number of row pixels of a resolution of the image is less than or equal to a half of the number of row pixels of a resolution of a display apparatus and the number of column pixels of the resolution of the image is less than or equal to a half of the number of column pixels of the resolution of the display apparatus, determine that the transmission mode corresponding to the amount of data of the image is a low-speed transmission mode; and

when the number of row pixels of the resolution of the image is greater than a half of the number of row pixels of the resolution of the display apparatus and the number of column pixels of the resolution of the image is greater than a half of the number of column pixels of the resolution of the display apparatus, determine that the transmission mode corresponding to the amount of data of the image is a high-speed transmission mode;

wherein power consumption required for transmitting the mode selection information in the low-speed transmission mode is less than power consumption required for transmitting the mode selection information in the high-speed transmission mode.

When it is determined that the transmission mode corresponding to the amount of data of the image is a low-speed transmission mode according to the predetermined condition, mode selection information corresponding to the low-speed transmission mode is determined, thereby reducing the power consumption required for data transmission between the system module and the timing controller through the mode selection information corresponding to the low-speed transmission mode in the process of the data transmission.

Preferably, the mode selection information comprises mode conversion information for indicating the timing controller to select an operation mode and a resolution required to be used by the display apparatus for displaying an image corresponding to the operation mode used by the timing controller.

Preferably, the mode selection information module is further configured to:

when the transmission mode corresponding to the amount of data is the low-speed transmission mode, determine the low-speed transmission mode and a half of the highest resolution of the display apparatus as the mode selection information; and

i. when the transmission mode corresponding to the amount of data is the high-speed transmission mode, determine the high-speed transmission mode and the highest resolution of the display apparatus as the mode selection information.

Since a resolution corresponding to the low-speed transmission mode is small, an amount of data included in the mode selection information corresponding to the low-speed transmission mode is small, thereby reducing the power consumption required for transmitting the mode selection information.

Preferably, the mode selection information module is further configured to:

transmit the mode selection information to the timing controller through an auxiliary data channel.

The mode selection information is transmitted to the timing controller through the auxiliary data channel without adding additional wiring for transmitting the mode selection information.

The embodiments of the present disclosure provide an apparatus for transmitting data, comprising:

a receiving module configured to receive mode selection information transmitted by a system module, wherein the mode selection information is indication information for indicating a timing controller to select different operation modes which is determined by the system module according to a transmission mode corresponding to an amount of data of an image; and

a transmitting module configured to determine the operation mode of the timing controller according to the mode selection information and transmit a driving signal corresponding to the operation mode of the timing controller to a display apparatus.

With the apparatus for transmitting data according to the embodiments of the present disclosure, the timing controller firstly receives mode selection information transmitted by a system module; and then determines an operation mode of the timing controller according to the mode selection information and transmits a driving signal corresponding to the operation mode of the timing controller to a display apparatus. That is, in the embodiments of the present disclosure, the mode selection information for indicating the timing controller to select different operation modes is determined according to the amount of data of the image. Therefore, without influencing normal display of an image, when the amount of data of the image is small, the amount of data included in the corresponding mode selection information and thus a frequency of a driving signal corresponding to the amount of data are also small, thereby reducing the frequency of the driving signal in the process of data transmission between the timing controller and the display apparatus as well as the power consumption required in the process of data transmission, and saving resources.

Preferably, the mode selection information comprises mode conversion information for indicating the timing controller to select an operation mode and a resolution required to be used by the display apparatus for displaying an image corresponding to the operation mode used by the timing controller.

Preferably, the transmitting module is configured to:

determine that the operation mode of the timing controller is a low-speed transmission mode according to the mode conversion information in the mode selection information being the low-speed transmission mode, determine a driving frequency of a driver of the timing controller for driving row pixels in the low-speed transmission mode according to the number of row pixels of the resolution in the mode selection information and transmit the driving frequency of the driver for driving row pixels to the display apparatus; and determine a driving frequency of a driver of the timing controller for driving column pixels in the low-speed transmission mode according to the number of column pixels of the resolution in the mode selection information and transmit the driving frequency of the driver for driving column pixels to the display apparatus; or

determine that the operation mode of the timing controller is a high-speed transmission mode according to the mode conversion information in the mode selection information being the high-speed transmission mode, determine a driving frequency of the driver of the timing controller for driving row pixels in the high-speed transmission mode according to the number of row pixels of the resolution in the mode selection information and transmit the driving frequency of the driver for driving row pixels to the display apparatus; and determine a driving frequency of the driver of the timing controller for driving column pixels in the high-speed transmission mode according to the number of column pixels of the resolution in the mode selection information and transmit the driving frequency of the driver for driving column pixels to the display apparatus;

wherein power consumption required for transmitting the driving frequency in the low-speed transmission mode is less than power consumption required for transmitting the driving frequency in the high-speed transmission mode.

In the data transmission between the timing controller and the display apparatus, the power consumption required in the process of transmitting the driving signal determined in the low-speed transmission mode is less than the power consumption required in the process of transmitting the driving signal determined in the high-speed transmission mode.

Preferably, the transmitting module is further configured to:

when it is determined that the operation mode of the timing controller is the low-speed transmission mode, transmit a control signal for indicating a first switch unit and a second switch unit of the display apparatus to switch on to the display apparatus; and

when it is determined that the operation mode of the timing controller is the high-speed transmission mode, transmit a control signal for indicating the first switch unit and the second switch unit of the display apparatus to be switched off to the display apparatus;

wherein the first switch unit is configured to control whether to conduct a group of gate lines comprised of two adjacent rows of gate lines, and different groups of gate lines comprise different gate lines, and the second switch unit is configured to control whether to conduct a group of data lines comprised of two adjacent columns of data lines, and different groups of data lines comprise different data lines.

The display apparatus is controlled through the control signal transmitted by the timing controller in the low-speed transmission mode, thereby reducing the power consumption required by the display apparatus for displaying an image.

The embodiments of the present disclosure provide a display apparatus comprising the apparatus for transmitting data according to the embodiments of the present disclosure.

Preferably, two adjacent rows of gate lines in the display apparatus form a group of gate lines, different groups of gate lines comprise different gate lines, and a first switch unit for controlling whether to conduct two rows of gate lines in each group of gate lines is arranged between the two rows of gate lines; and

two adjacent columns of data lines in the display apparatus form a group of data lines, different groups of data lines comprise different data lines, and a second switch unit for controlling whether to conduct two columns of data lines in each group of data lines is arranged between the two columns of data lines.

When both the first switch unit and the second switch unit are switched on, the power consumption required by the display apparatus for displaying an image is small.

Preferably, the first switch unit is a thin film transistor having a source and a drain respectively connected to two rows of gate lines in a group of gate lines where the thin film transistor is located, and a gate connected to a control signal output for indicating the first switch unit to be switched on or switched off; and

the second switch unit is a thin film transistor having a source and a drain respectively connected to two columns of data lines in a group of data lines where the thin film transistor is located, and a gate connected to a control signal output for indicating the second switch unit to be switched on or switched off.

### BRIEF DESCRIPTION OF THE DRAWINGS

FIG. 1 is a flowchart of data transmission according to the related art;

FIG. 2 is a flowchart of another data transmission according to the related art;

FIG. 3 is a flowchart of a method for transmitting data according to an embodiment of the present disclosure;

FIG. 4 is a flowchart of another method for transmitting data according to an embodiment of the present disclosure;

FIG. 5(a) is a diagram of driving frequencies for driving row pixels and column pixels in a pixel unit in a high-speed transmission mode according to an embodiment of the present disclosure;

FIG. 5(b) is a diagram of driving frequencies for driving row pixels and column pixels in a pixel unit in a low-speed transmission mode according to an embodiment of the present disclosure;

FIG. 6 is a structural diagram of an apparatus for transmitting data according to an embodiment of the present disclosure;

FIG. 7 is a structural diagram of another apparatus for transmitting data according to an embodiment of the present disclosure;

FIG. 8 is a structural diagram of a display apparatus according to an embodiment of the present disclosure;

FIG. 9 is a structural diagram of another display apparatus according to an embodiment of the present disclosure; and

FIG. 10 is a flowchart of another method for transmitting data according to an embodiment of the present disclosure.

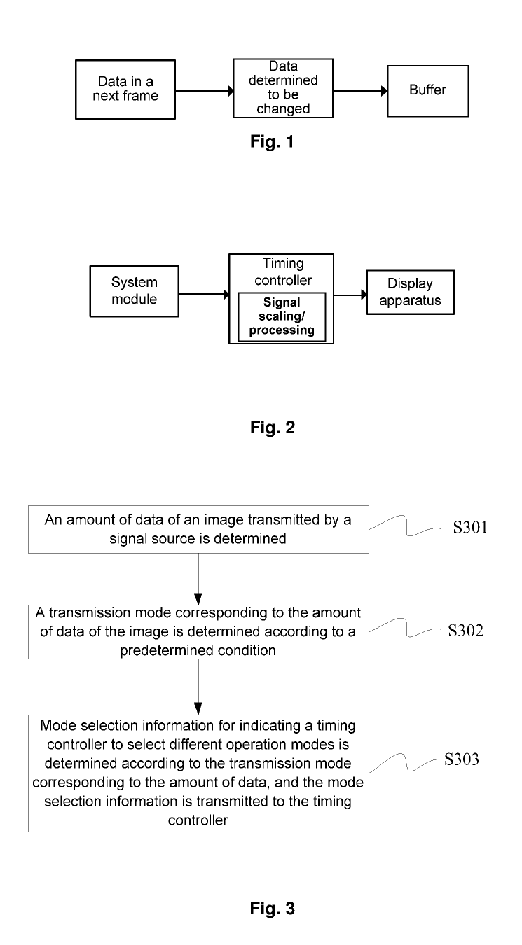

### DETAILED DESCRIPTION

In order to make the purpose, technical solutions, and advantages of the present disclosure more clearly, the present disclosure will be further described in detail below with reference to the accompanying drawings. Obviously, the embodiments as described are merely a part of embodiments of the present disclosure instead of all the embodiments. All other embodiments obtained by those skilled persons in the art based on the embodiments of the present disclosure without contributing any creative labor should belong to the scope protected by the present disclosure.

Embodiments of the present disclosure provide a method and apparatus for transmitting data, and a display apparatus, to reduce an amount of data in the process of data transmission without influencing normal display of an image, thereby reducing power consumption required in the process of data transmission and saving resources.

It should be noted that the method for transmitting data according to the embodiments of the present disclosure does not conflict with the method for transmitting data according to the related art, and both methods can be used in combination.

The technical solutions according to the embodiments of the present disclosure will be described in detail below with reference to accompanying drawing.

### First Embodiment

As shown in FIG. 3, at a system module side, a method for transmitting data according to the embodiment of the present disclosure is illustrated. The method comprises the following steps.

In S301, an amount of data of an image transmitted by a signal source is determined.

After receiving an input signal transmitted by the signal source, the system module converts the input signal into the amount of data of the image. The amount of data of the image comprises a resolution and the number of color bits of the image. The resolution of the image comprises the number of row pixels and the number of column pixels. For example, if A is used to represent the number of row pixels of the image of the signal source, B is used to represent the number of column pixels of the image of the signal source, and C is used to represent the number of color bits of the image of the signal source, the amount of data of the image of the signal source is A*B*C.

In S302, a transmission mode corresponding to the amount of data of the image is determined according to a predetermined condition.

Determining a transmission mode corresponding to the amount of data of the image according to a predetermined condition comprises:

when the number of row pixels of the resolution of the image is less than or equal to a half of the number of row pixels of a resolution of a display apparatus and the number of column pixels of the resolution of the image is less than or equal to a half of the number of column pixels of the resolution of the display apparatus, determining that the transmission mode corresponding to the amount of data of the image is a low-speed transmission mode; and

when the number of row pixels of the resolution of the image is greater than a half of the number of row pixels of the resolution of the display apparatus and the number of column pixels of the resolution of the image is greater than a half of the number of column pixels of the resolution of the display apparatus, determining that the transmission mode corresponding to the amount of data of the image is a high-speed transmission mode;

wherein power consumption required for transmitting mode selection information in the low-speed transmission mode is less than power consumption required for transmitting mode selection information in the high-speed transmission mode.

For example, assuming that D is used to represent the number of row pixels of an image of the display apparatus, E is used to represent the number of column pixels of the image of the display apparatus, and F is used to represent the number of color bits of the display apparatus, an amount of data of the image of the display apparatus is D*E*F. When A≦½D and B≦½E, i.e., when A*B≦¼D*E, it is determined that the transmission mode corresponding to the amount of data of the image of the signal source is a low-speed transmission mode; and when A>½D and B>½E, i.e., when A*B>¼D*E, it is determined that the transmission mode corresponding to the amount of data of the image of the signal source is a high-speed transmission mode.

It should be noted that the predetermined condition in the embodiment of the present disclosure is to determine a low-speed transmission mode and a high-speed transmission mode by comparing the number of row pixels of the image of the signal source with a half of the number of row pixels of the display apparatus and comparing the number of column pixels of the image of the signal source with a half of the number of column pixels of the display apparatus. Of course, the predetermined condition may be changed according to practical requirements. For example, the predetermined condition is to determine a low-speed transmission mode, a medium-speed transmission mode, and a high-speed transmission mode by comparing the number of row pixels of the image of the signal source with a quarter of the number of row pixels of the display apparatus and comparing the number of column pixels of the image of the signal source with a quarter of the number of column pixels of the display apparatus. Specifically, for example, when A≦¼D and B≦¼E, i.e., when A*B≦ 1/16D*E, it is determined that the transmission mode corresponding to the amount of data of the image of the signal source is a low-speed transmission mode; when ¼D<A≦½D and ¼E<B≦½E, i.e., when 1/16D*E<A*B≦¼D*E, it is determined that the transmission mode corresponding to the amount of data of the image of the signal source is a medium-speed transmission mode; and when A>½D and B>½E, i.e., when A*B>¼D*E, it is determined that the transmission mode corresponding to the amount of data of the image of the signal source is a high-speed transmission mode. The content of the predetermined condition is not specifically defined in the embodiment of the present disclosure. All methods for determining a transmission mode according to a size of a resolution should belong to the protection scope of the embodiment of the present disclosure.

In S303, mode selection information for indicating a timing controller to select different operation modes is determined according to the transmission mode corresponding to the amount of data, and the mode selection information is transmitted to the timing controller.

The mode selection information in S303 comprises mode conversion information for indicating the timing controller to select an operation mode and a resolution required to be used by the display apparatus for displaying an image corresponding to the operation mode used by the timing controller.

It should be noted that the mode selection information further comprises the number of color bits required to be used by the display apparatus for displaying an image corresponding to the operation mode used by the timing controller and other reserved content.

Determining the mode selection information according to the transmission mode corresponding to the amount of data comprises:

when the transmission mode corresponding to the amount of data is the low-speed transmission mode, determining the low-speed transmission mode and a half of the highest resolution of the display apparatus as the mode selection information; and

when the transmission mode corresponding to the amount of data is the high-speed transmission mode, determining the high-speed transmission mode and the highest resolution of the display apparatus as the mode selection information.

It should be emphasized that in a case of the low-speed transmission mode, the highest resolution of the display apparatus is reduced by a half. However, in order to reduce the power consumption in the process of data transmission, determination of a quarter of the resolution or another value as the mode selection information without influencing normal display of an image should belong to the protection scope of the embodiment of the present disclosure.

Transmitting the mode selection information to the timing controller in S303 comprises:

transmitting the mode selection information to the timing controller through an auxiliary data channel.

When data transmission is implemented between the system module and the timing controller, in order to enable the mode selection information of the present disclosure to be transmitted normally, an auxiliary data channel reserved for a display interface may be selected for interaction between the system module and the timing controller, without adding additional wiring for transmitting the mode selection information.

In conclusion, with the method for transmitting data according to the embodiment of the present disclosure, when it is determined that the transmission mode corresponding to the amount of data of the image of the signal source is a low-speed transmission mode, mode selection information corresponding to the low-speed transmission mode is determined. Since the amount of data included in the corresponding mode selection information in the low-speed transmission mode is reduced, the amount of data in the process of data transmission between the system module and the timing controller is reduced without influencing normal display of an image, thereby reducing the power consumption required in the process of data transmission and saving resources.

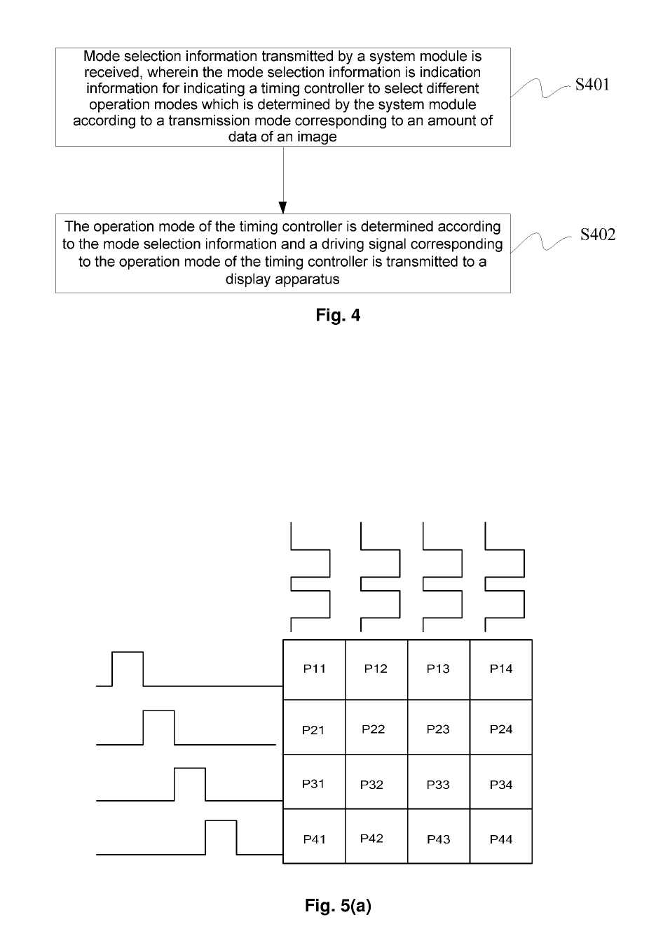

As shown in FIG. 4, at a timing controller side, another method for transmitting data according to an embodiment of the present disclosure is illustrated. The method comprises the following steps.

In S401, mode selection information transmitted by a system module is received, wherein the mode selection information is indication information for indicating a timing controller to select different operation modes which is determined by the system module according to a transmission mode corresponding to an amount of data of an image.

The mode selection information in S401 comprises mode conversion information for indicating the timing controller to select an operation mode and a resolution required to be used by the display apparatus for displaying an image corresponding to the operation mode used by the timing controller.

In S402, the operation mode of the timing controller is determined according to the mode selection information and a driving signal corresponding to the operation mode of the timing controller is transmitted to a display apparatus.

Determining the operation mode of the timing controller according to the mode selection information and transmitting a driving signal corresponding to the operation mode of the timing controller to a display apparatus in step S402 comprises:

determining that the operation mode of the timing controller is a low-speed transmission mode according to the mode conversion information in the mode selection information being the low-speed transmission mode, determining a driving frequency of a driver of the timing controller for driving row pixels in the low-speed transmission mode according to the number of row pixels of the resolution in the mode selection information and transmitting the driving frequency of the driver for driving row pixels to the display apparatus; and determining a driving frequency of a driver of the timing controller for driving column pixels in the low-speed transmission mode according to the number of column pixels of the resolution in the mode selection information and transmitting the driving frequency of the driver for driving column pixels to the display apparatus; or

determining that the operation mode of the timing controller is a high-speed transmission mode according to the mode conversion information in the mode selection information being the high-speed transmission mode, determining a driving frequency of the driver of the timing controller for driving row pixels in the high-speed transmission mode according to the number of row pixels of the resolution in the mode selection information and transmitting the driving frequency of the driver for driving row pixels to the display apparatus; and determining a driving frequency of the driver of the timing controller for driving column pixels in the high-speed transmission mode according to the number of column pixels of the resolution in the mode selection information and transmitting the driving frequency of the driver for driving column pixels to the display apparatus;

wherein power consumption required for transmitting the driving frequency in the low-speed transmission mode is less than power consumption required for transmitting the driving frequency in the high-speed transmission mode.

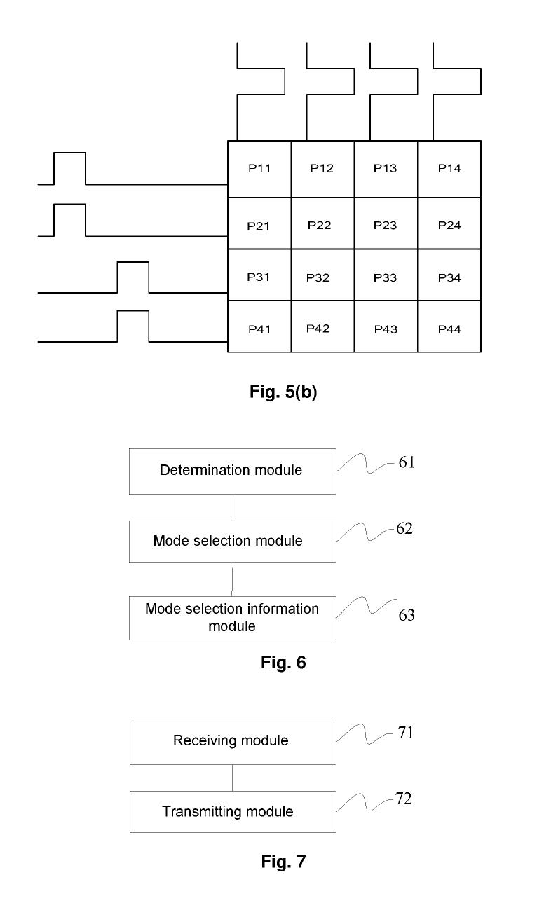

For example, if the mode selection information comprises a low-speed transmission mode, when the number of row pixels is a half of the number of row pixels in the display apparatus and the number of column pixels is a half of the number of column pixels in the display apparatus, it is determined that the driving frequency for row pixels displayed by the display apparatus is reduced by a half, and the driving frequency for column pixels displayed by the display apparatus is reduced by a half. As shown in FIGS. 5(a) and 5(b), illustrated are diagrams of driving frequencies transmitted by a timing controller in a high-speed transmission mode and a low-speed transmission mode respectively. Assuming that the number of row pixels is 4 and the number of column pixels is 4, a resolution of the display apparatus is 16. In a high-speed transmission mode, a driving frequency for driving row pixels is f1 in FIG. 5(a), and a driving frequency for driving column pixels is f2 in FIG. 5(a), wherein P11 represents a sub-pixel unit in a first row and a first column, P12 represents a sub-pixel unit in a first row and a second column, and so on. In a low-speed transmission mode, a driving frequency for driving row pixels is f3 in FIG. 5(b), and a driving frequency for driving column pixels is f4 in FIG. 5(b). Obviously, the driving frequency for driving row pixels in the low-speed transmission mode is a half of the driving frequency in the high-speed transmission mode, and the driving frequency for driving column pixels in the low-speed transmission mode is a half of the driving frequency in the high-speed transmission mode. In this way, the driving frequency is reduced, thereby reducing the output power consumption of the timing controller.

Of course, the driving frequency for the row pixels and the driving frequency for the column pixels may be determined according to practical conditions. For example, if the mode selection information comprises a low-speed transmission mode, when the number of row pixels is a quarter of the number of the row pixels in the display apparatus, and the number of column pixels is a quarter of the number of the column pixels in the display apparatus, it is determined that the driving frequency for the row pixels displayed by the display apparatus is reduced to a quarter of the original driving frequency, and the driving frequency for the column pixels displayed by the display apparatus is reduced to a quarter of the original driving frequency. Determination of a driving frequency is not specifically defined in the embodiment of the present disclosure. All methods for determining a driving frequency required for driving row pixels and a driving frequency required for driving column pixels according to the number of row pixels and the number of column pixels in a resolution should belong to the protection scope of the embodiment of the present disclosure.

The method for transmitting data further comprises:

when it is determined that the operation mode of the timing controller is the low-speed transmission mode, transmitting a control signal for indicating a first switch unit and a second switch unit of the display apparatus to be switched on to the display apparatus; and

when it is determined that the operation mode of the timing controller is the high-speed transmission mode, transmitting a control signal for indicating the first switch unit and the second switch unit of the display apparatus to be switched off to the display apparatus;

wherein the first switch unit is configured to control whether to conduct a group of gate lines comprised of two adjacent rows of gate lines, and different groups of gate lines comprise different gate lines, and the second switch unit is configured to control whether to conduct a group of data lines comprised of two adjacent columns of data lines, and different groups of data lines comprise different data lines.

The display apparatus is controlled by the control signal transmitted by the timing controller in a low-speed transmission mode, thereby reducing the power consumption required by the display apparatus for displaying an image.

In conclusion, when the timing controller determines that the operation mode of the timing controller is a low-speed transmission mode according to the received mode selection information transmitted by the system module, the timing controller determines a driving signal corresponding to the low-speed transmission mode, and transmits the driving signal to the display apparatus. Since both a driving frequency for driving row pixels and a driving frequency for driving column pixels in the driving signal corresponding to the low-speed transmission mode are reduced, in the process of data transmission between the timing controller and the display apparatus, a frequency of the driving signal determined in the low-speed transmission mode is reduced, thereby reducing the power consumption required for the data transmission between the timing controller and the display apparatus and saving resources without influencing normal display of an image.

Further, in order to further reduce the power consumption of the display apparatus in the process of displaying the image, the timing controller may transmit a control signal for indicating a first switch unit and a second switch unit of the display apparatus to be switched on to the display apparatus, thereby reducing the number of output row pixels and the number of output column pixels in the display apparatus by switching on the first switch unit and the second switch unit. The first switch unit and the second switch unit in the display apparatus are improvements made to the display apparatus according to the embodiment of the present disclosure. The specific improvement solutions will be described in detail when the display apparatus is discussed.

As shown in FIG. 6, at a system module side, an apparatus for transmitting data according to an embodiment of the present disclosure is illustrated. The apparatus comprises a determination module 61, a mode selection module 62 and a mode selection information module 63.

The determination module 61 is configured to determine an amount of data of an image transmitted by a signal source.

The mode selection module 62 is configured to determine a transmission mode corresponding to the amount of data of the image according to a predetermined condition.

Preferably, the mode selection module 62 is further configured to:

when the number of row pixels of a resolution of the image is less than or equal to a half of the number of row pixels of a resolution of a display apparatus and the number of column pixels of the resolution of the image is less than or equal to a half of the number of column pixels of the resolution of the display apparatus, determine that the transmission mode corresponding to the amount of data of the image is a low-speed transmission mode; and

when the number of row pixels of the resolution of the image is greater than a half of the number of row pixels of the resolution of the display apparatus and the number of column pixels of the resolution of the image is greater than a half of the number of column pixels of the resolution of the display apparatus, determine that the transmission mode corresponding to the amount of data of the image is a high-speed transmission mode;

wherein power consumption required for transmitting the mode selection information in the low-speed transmission mode is less than power consumption required for transmitting the mode selection information in the high-speed transmission mode.

When it is determined that the transmission mode corresponding to the amount of data of the image is a low-speed transmission mode according to the predetermined condition, mode selection information corresponding to the low-speed transmission mode is determined, thereby reducing the power consumption required for data transmission between the system module and the timing controller through the mode selection information corresponding to the low-speed transmission mode in the process of the data transmission.

The mode selection information module 63 is configured to determine mode selection information for indicating a timing controller to select different operation modes according to the transmission mode corresponding to the amount of data, and transmit the mode selection information to the timing controller.

Preferably, the mode selection information comprises mode conversion information for indicating the timing controller to select an operation mode and a resolution required to be used by the display apparatus for displaying an image corresponding to the operation mode used by the timing controller.

Preferably, the mode selection information module 63 is further configured to:

when the transmission mode corresponding to the amount of data is the low-speed transmission mode, determine the low-speed transmission mode and a half of the highest resolution of the display apparatus as the mode selection information; and

when the transmission mode corresponding to the amount of data is the high-speed transmission mode, determine the high-speed transmission mode and the highest resolution of the display apparatus as the mode selection information.

Since a resolution corresponding to the low-speed transmission mode is small, an amount of data included in the mode selection information corresponding to the low-speed transmission mode is small, thereby reducing the power consumption required for transmitting the mode selection information.

Preferably, the mode selection information module 63 is further configured to:

transmit the mode selection information to the timing controller through an auxiliary data channel.

The mode selection information is transmitted to the timing controller through the auxiliary data channel without adding additional wiring for transmitting the mode selection information.

In conclusion, with the apparatus for transmitting data according to the embodiment of the present disclosure, the system module firstly determines an amount of data of an image transmitted by a signal source; then determines a transmission mode corresponding to the amount of data of the image according to a predetermined condition; and finally determines mode selection information for indicating a timing controller to select different operation modes according to the transmission mode corresponding to the amount of data, and transmits the mode selection information to the timing controller. That is, in the embodiment of the present disclosure, the mode selection information for indicating the timing controller to select different operation modes is determined according to the amount of data of the image. Therefore, without influencing normal display of an image, when the amount of data of the image is small, the amount of data included in the corresponding mode selection information is also small, thereby reducing the amount of data in the process of data transmission between the system module and the timing controller as well as the power consumption required in the process of data transmission, and saving resources.

As shown in FIG. 7, at a timing controller side, another apparatus for transmitting data according to an embodiment of the present disclosure is illustrated. The apparatus comprises a receiving module 71 and a transmitting module 72.

The receiving module 71 is configured to receive mode selection information transmitted by a system module, wherein the mode selection information is indication information for indicating the timing controller to select different operation modes which is determined by the system module according to a transmission mode corresponding to an amount of data of an image.

Preferably, the mode selection information comprises mode conversion information for indicating the timing controller to select an operation mode and a resolution required to be used by the display apparatus for displaying an image corresponding to the operation mode used by the timing controller.

The transmitting module 72 is configured to determine the operation mode of the timing controller according to the mode selection information and transmit a driving signal corresponding to the operation mode of the timing controller to a display apparatus.

Preferably, the transmitting module 72 is further configured to:

determine that the operation mode of the timing controller is a low-speed transmission mode according to the mode conversion information in the mode selection information being the low-speed transmission mode, determine a driving frequency of a driver of the timing controller for driving row pixels in the low-speed transmission mode according to the number of row pixels of the resolution in the mode selection information and transmit the driving frequency of the driver for driving row pixels to the display apparatus; and determine a driving frequency of a driver of the timing controller for driving column pixels in the low-speed transmission mode according to the number of column pixels of the resolution in the mode selection information and transmit the driving frequency of the driver for driving column pixels to the display apparatus; or

determine that the operation mode of the timing controller is a high-speed transmission mode according to the mode conversion information in the mode selection information being the high-speed transmission mode, determine a driving frequency of the driver of the timing controller for driving row pixels in the high-speed transmission mode according to the number of row pixels of the resolution in the mode selection information and transmit the driving frequency of the driver for driving row pixels to the display apparatus; and determine a driving frequency of the driver of the timing controller for driving column pixels in the high-speed transmission mode according to the number of column pixels of the resolution in the mode selection information and transmit the driving frequency of the driver for driving column pixels to the display apparatus;

wherein power consumption required for transmitting the driving frequency in the low-speed transmission mode is less than power consumption required for transmitting the driving frequency in the high-speed transmission mode.

In the data transmission between the timing controller and the display apparatus, the power consumption required in the process of transmitting the driving signal determined in the low-speed transmission mode is less than the power consumption required in the process of transmitting the driving signal determined in the high-speed transmission mode.

Preferably, the transmitting module 72 is further configured to:

when it is determined that the operation mode of the timing controller is the low-speed transmission mode, transmit a control signal for indicating a first switch unit and a second switch unit of the display apparatus to be switched on to the display apparatus; and

when it is determined that the operation mode of the timing controller is the high-speed transmission mode, transmit a control signal for indicating the first switch unit and the second switch unit of the display apparatus to be switched off to the display apparatus;

wherein the first switch unit is configured to control whether to conduct a group of gate lines comprised of two adjacent rows of gate lines, and different groups of gate lines comprise different gate lines, and the second switch unit is configured to control whether to conduct a group of data lines comprised of two adjacent columns of data lines, and different groups of data lines comprise different data lines.

The display apparatus is controlled through the control signal transmitted by the timing controller in the low-speed transmission mode, thereby reducing the power consumption required by the display apparatus for displaying an image.

With the apparatus for transmitting data according to the embodiment of the present disclosure, the timing controller firstly receives mode selection information transmitted by a system module; and then determines an operation mode of the timing controller according to the mode selection information and transmits a driving signal corresponding to the operation mode of the timing controller to a display apparatus. That is, in the embodiment of the present disclosure, the mode selection information for indicating the timing controller to select different operation modes is determined according to the amount of data of the image. Therefore, without influencing normal display of an image, when the amount of data of the image is small, the amount of data included in the corresponding mode selection information and thus a frequency of a driving signal corresponding to the amount of data are also small, thereby reducing the frequency of the driving signal in the process of data transmission between the timing controller and the display apparatus as well as the power consumption required in the process of data transmission, and saving resources.

A display apparatus according to an embodiment of the present disclosure comprises the apparatus for transmitting data according to the embodiment of the present disclosure included at the system module side and the apparatus for transmitting data according to the embodiment of the present disclosure included at the timing controller side.

The display apparatus according to the embodiment of the present disclosure may be any product or component having a display function, such as a liquid display panel, a liquid display apparatus, a mobile phone, a tablet computer, a television, a display, a notebook computer, a digital frame, a navigator or the like.

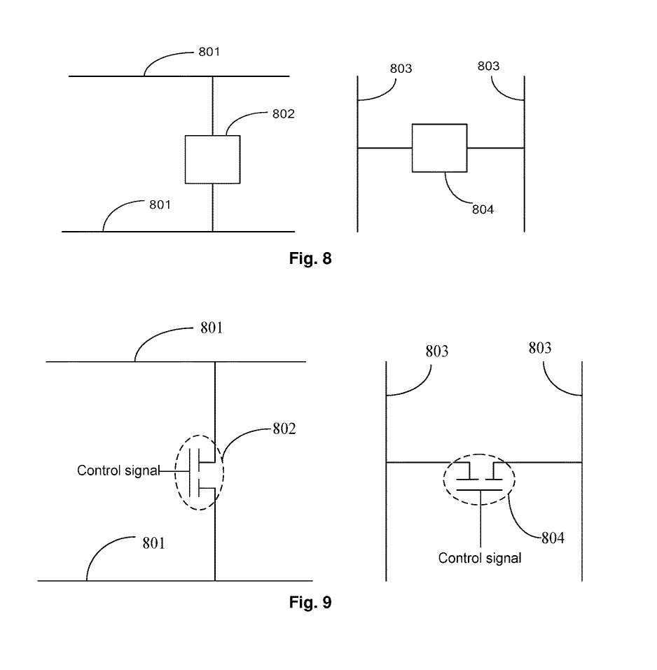

As shown in FIG. 8, two adjacent rows of gate lines 801 in the display apparatus form a group of gate lines, different groups of gate lines comprise different gate lines 801, and a first switch unit 802 for controlling whether to conduct two rows of gate lines 801 in each group of gate lines is arranged between the two rows of gate lines; and

two adjacent columns of data lines 803 in the display apparatus form a group of data lines, different groups of data lines comprise different data lines 803, and a second switch unit 804 for controlling whether to conduct two columns of data lines 803 in each group of data lines is arranged between the two columns of data line.

With the display apparatus according to the embodiment of the present disclosure, when both the first switch unit and the second switch unit are switched on, the number of output row pixels and the number of output column pixels in the display apparatus are reduced by a half, thereby reducing the power consumption required by the display apparatus for displaying an image.

It should be noted that the first switch unit may be arranged according to practical requirements. For example, if the number of row pixels in the display apparatus is required to be reduced to a quarter of the original number, it needs to arrange a first switch unit among gate lines of each group of gate lines and each group of gate lines comprises four gate lines. Similarly, the second switch unit may also be arranged according to practical requirements. In conclusion, in order to reduce the number of output row pixels and/or the number of output column pixels of the display apparatus, a switch unit is added between gate lines and/or data lines, to enable signals output by various groups of gate lines and/or data lines to be equal. All methods which comply with the above principle should belong to the protection scope of the embodiment of the present disclosure.

As shown in FIG. 9, the first switch unit 802 is a Thin Film Transistor (TFT), having a source and a drain respectively connected to two rows of gate lines 801 in a group of gate lines where the thin film transistor is located, and a gate connected to a control signal output for indicating the first switch unit to be switched on or switched off; and

the second switch unit 804 is a thin film transistor having a source and a drain respectively connected to two columns of data lines 803 in a group of data lines where the thin film transistor is located, and a gate connected to a control signal output for indicating the second switch unit to be switched on or switched off.

When the thin film transistor is an N-type TFT, a control signal for indicating the TFT to be switched on is a high level for enabling the TFT to be switched on, and a control signal for indicating the TFT to be switched off is a low level for enabling the TFT to be switched off. When the thin film transistor is a P-type TFT, a control signal for indicating the TFT to be switched on is a low level for enabling the TFT to be switched on, and a control signal for indicating the TFT to be switched off is a high level for enabling the TFT to be switched off.

It should be noted that the first switch unit and the second switch unit according to the embodiment of the present disclosure may be TFTs, or other switch elements, which will not be specifically defined in the embodiment of the present disclosure.

### Second Embodiment

In the second embodiment, how to implement data transmission and reduce the power consumption required in the process of the data transmission through a method for transmitting data according to an embodiment of the present disclosure after an input signal transmitted by a signal source is received will be described in detail.

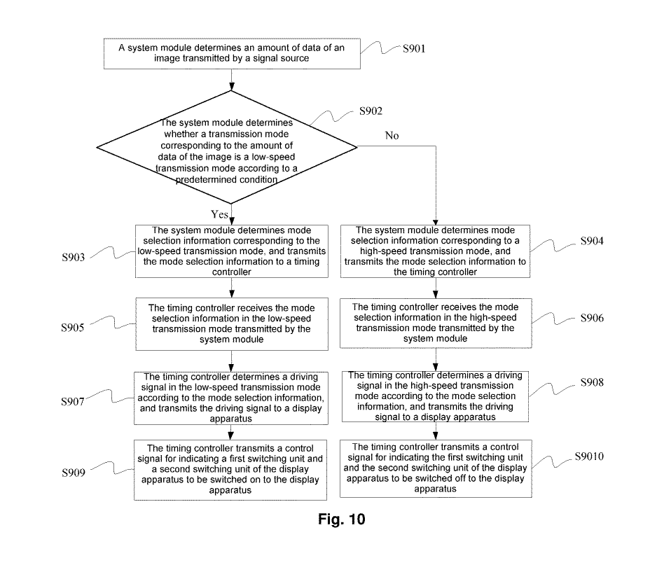

As shown in FIG. 10, the method for transmitting data according to the embodiment of the present disclosure is illustrated. The method comprises the following steps.

In S901, a system module determines an amount of data of an image transmitted by a signal source.

In S902, the system module determines whether a transmission mode corresponding to the amount of data of the image is a low-speed transmission mode according to a predetermined condition, and if so, implements step S903; otherwise, implements step S904.

In S903, the system module determines mode selection information corresponding to the low-speed transmission mode, transmits the mode selection information to a timing controller, and then implements step S905.

In S904, the system module determines mode selection information corresponding to a high-speed transmission mode, transmits the mode selection information to the timing controller, and then implements step S906.

In S905, the timing controller receives the mode selection information in the low-speed transmission mode transmitted by the system module, and then implements step S907.

In S906, the timing controller receives the mode selection information in the high-speed transmission mode transmitted by the system module, and then implements step S908.

In S907, the timing controller determines a driving signal in the low-speed transmission mode according to the mode selection information, transmits the driving signal to a display apparatus, and then implements step S909.

In S908, the timing controller determines a driving signal in the high-speed transmission mode according to the mode selection information, transmits the driving signal to a display apparatus, and then implements step S9010.

In S909, the timing controller transmits a control signal for indicating a first switch unit and a second switch unit of the display apparatus to be switched on to the display apparatus; and

In S9010, the timing controller transmits a control signal for indicating the first switch unit and the second switch unit of the display apparatus to be switched off to the display apparatus.

In conclusion, when the timing controller determines that the transmission mode corresponding to the amount of data of the image transmitted by the signal source is a low-speed transmission mode, the timing controller then determines mode selection information in the low-speed transmission mode, so that when the mode selection information in the low-speed transmission mode is transmitted between the system module and the timing controller, the amount of data between the system module and the timing controller is reduced, thereby reducing the power consumption required for data transmission between the system module and the timing controller; and when an operation mode corresponding to the mode selection information received by the timing controller is a low-speed transmission mode, the timing controller determines a corresponding driving signal in the low-speed transmission mode, so that when the timing controller transmits the driving signal to the display apparatus, the power consumption required for transmitting the driving signal is reduced. In this way, the power consumption required in the whole process of data transmission is reduced. Further, in order to reduce the numbers of row pixels and column pixels displayed in the display apparatus, the first switch unit is switched on to enable various gate lines in each group of gate lines to output the same signal at the same time and the second switch unit is switched on to enable various data lines in each group of data lines to output the same signal at the same time, thereby reducing the power consumption for display by the display apparatus.

In conclusion, the method for transmitting data according to the embodiment of the present disclosure comprises firstly determining, by a system module, an amount of data of an image transmitted by a signal source; then determining a transmission mode corresponding to the amount of data of the image according to a predetermined condition; and finally determining mode selection information for indicating a timing controller to select different operation modes according to the transmission mode corresponding to the amount of data, and transmitting the mode selection information to the timing controller. That is, in the embodiment of the present disclosure, the mode selection information for indicating the timing controller to select different operation modes is determined according to the amount of data of the image. Therefore, without influencing normal display of an image, when the amount of data of the image is small, the amount of data included in the corresponding mode selection information is also small, thereby reducing the amount of data in the process of data transmission between the system module and the timing controller as well as the power consumption required in the process of data transmission, and saving resources.

Obviously, those skilled in the art can make various modifications and variations to the present disclosure without departing from the spirit and scope of the present disclosure. Thus, if these modifications and variations of the present disclosure belong to the scope of the claims of the present disclosure and the equivalent technologies thereof, the present disclosure is also intended to include these modifications and variations.

I/We claim:

1. A method for transmitting data, comprising:
determining an amount of data of an image transmitted by a signal source;
determining a transmission mode corresponding to the amount of data of the image according to a predetermined condition; and
determining mode selection information for indicating a timing controller to select different operation modes according to the transmission mode corresponding to the amount of data, and transmitting the mode selection information to the timing controller.

2. The method according to claim 1, wherein determining a transmission mode corresponding to the amount of data of the image according to a predetermined condition comprises:
when the number of row pixels of a resolution of the image is less than or equal to a half of the number of row pixels of a resolution of a display apparatus and the number of column pixels of the resolution of the image is less than or equal to a half of the number of column pixels of the resolution of the display apparatus, determining that the transmission mode corresponding to the amount of data of the image is a low-speed transmission mode; and
when the number of row pixels of the resolution of the image is greater than a half of the number of row pixels of the resolution of the display apparatus and the number of column pixels of the resolution of the image is greater than a half of the number of column pixels of the resolution of the display apparatus, determining that the transmission mode corresponding to the amount of data of the image is a high-speed transmission mode;
wherein power consumption required for transmitting the mode selection information in the low-speed transmission mode is less than power consumption required for transmitting the mode selection information in the high-speed transmission mode.

3. The method according to claim 2, wherein the mode selection information comprises mode conversion information for indicating the timing controller to select an operation mode and a resolution required to be used by the display apparatus for displaying an image corresponding to the operation mode used by the timing controller.

4. The method according to claim 3, wherein determining the mode selection information according to the transmission mode corresponding to the amount of data comprises:
when the transmission mode corresponding to the amount of data is the low-speed transmission mode, determining the low-speed transmission mode and a half of the highest resolution of the display apparatus as the mode selection information; and
when the transmission mode corresponding to the amount of data is the high-speed transmission mode, determining the high-speed transmission mode and the highest resolution of the display apparatus as the mode selection information.

5. The method according to claim 1, wherein transmitting the mode selection information to the timing controller comprises:
transmitting the mode selection information to the timing controller through an auxiliary data channel.

6. A method for transmitting data, comprising:
receiving mode selection information transmitted by a system module, wherein the mode selection information is indication information for indicating a timing controller to select different operation modes which is determined by the system module according to a transmission mode corresponding to an amount of data of an image; and
determining the operation mode of the timing controller according to the mode selection information and transmitting a driving signal corresponding to the operation mode of the timing controller to a display apparatus.

7. The method according to claim 6, wherein the mode selection information comprises mode conversion information for indicating the timing controller to select an operation mode and a resolution required to be used by the display apparatus for displaying an image corresponding to the operation mode used by the timing controller.

8. The method according to claim 7, wherein determining the operation mode of the timing controller according to the mode selection information and transmitting a driving signal corresponding to the operation mode of the timing controller to a display apparatus comprises:
determining that the operation mode of the timing controller is a low-speed transmission mode according to the mode conversion information in the mode selection information being the low-speed transmission mode, determining a driving frequency of a driver of the timing controller for driving row pixels in the low-speed transmission mode according to the number of row pixels of the resolution in the mode selection information and transmitting the driving frequency of the driver for driving row pixels to the display apparatus; and determining a driving frequency of a driver of the timing controller for driving column pixels in the low-speed transmission mode according to the number of column pixels of the resolution in the mode selection information and transmitting the driving frequency of the driver for driving column pixels to the display apparatus; or
determining that the operation mode of the timing controller is a high-speed transmission mode according to the mode conversion information in the mode selection information being the high-speed transmission mode, determining a driving frequency of the driver of the timing controller for driving row pixels in the high-speed transmission mode according to the number of row pixels of the resolution in the mode selection information and transmitting the driving frequency of the driver for driving row pixels to the display apparatus; and determining a driving frequency of the driver of the timing controller for driving column pixels in the high-speed transmission mode according to the number of column pixels of the resolution in the mode selection information and transmitting the driving frequency of the driver for driving column pixels to the display apparatus;
wherein power consumption required for transmitting the driving frequency in the low-speed transmission mode is less than power consumption required for transmitting the driving frequency in the high-speed transmission mode.

9. The method according to claim 8, further comprising:
when it is determined that the operation mode of the timing controller is the low-speed transmission mode, transmitting a control signal for indicating a first switch unit and a second switch unit of the display apparatus to be switched on to the display apparatus; and
when it is determined that the operation mode of the timing controller is the high-speed transmission mode, transmitting a control signal for indicating the first switch unit and the second switch unit of the display apparatus to be switched off to the display apparatus;
wherein the first switch unit is configured to control whether to conduct a group of gate lines comprised of two adjacent rows of gate lines, and different groups of gate lines comprise different gate lines; and the second switch unit is configured to control whether to conduct a group of data lines comprised of two adjacent columns of data lines, and different groups of data lines comprise different data lines.

10. An apparatus for transmitting data, comprising:
a determination module configured to determine an amount of data of an image transmitted by a signal source;
a mode selection module configured to determine a transmission mode corresponding to the amount of data of the image according to a predetermined condition; and
a mode selection information module configured to determine mode selection information for indicating a timing controller to select different operation modes according to the transmission mode corresponding to the amount of data, and transmit the mode selection information to the timing controller.

11. The apparatus according to claim 10, wherein the mode selection information comprises mode conversion information for indicating the timing controller to select an operation mode and a resolution required to be used by the display apparatus for displaying an image corresponding to the operation mode used by the timing controller.

12. An apparatus for transmitting data, comprising:
a receiving module configured to receive mode selection information transmitted by a system module, wherein the mode selection information is indication information for indicating a timing controller to select different operation modes which is determined by the system module according to a transmission mode corresponding to an amount of data of an image; and
a transmitting module configured to determine the operation mode of the timing controller according to the mode selection information and transmit a driving signal corresponding to the operation mode of the timing controller to a display apparatus.

13. The apparatus according to claim 12, wherein the mode selection information comprises mode conversion information for indicating the timing controller to select an operation mode and a resolution required to be used by the display apparatus for displaying an image corresponding to the operation mode used by the timing controller.

14. A display apparatus, comprising the apparatus for transmitting data according to claim 10.

15. The display apparatus according to claim 14, wherein two adjacent rows of gate lines in the display apparatus form a group of gate lines, different groups of gate lines comprise different gate lines, and a first switch unit for controlling whether to conduct two rows of gate lines in each group of gate lines is arranged between the two rows of gate lines; and
two adjacent columns of data lines in the display apparatus form a group of data lines, different groups of data lines comprise different data lines, and a second switch unit for controlling whether to conduct two columns of data lines in each group of data lines is arranged between the two columns of data lines.

16. The display apparatus according to claim 15, wherein the first switch unit is a thin film transistor having a source and a drain respectively connected to two rows of gate lines in a group of gate lines where the thin film transistor is located, and a gate connected to a control signal output for indicating the first switch unit to be switched on or switched off; and
the second switch unit is a thin film transistor having a source and a drain respectively connected to two columns of data lines in a group of data lines where the thin film transistor is located, and a gate connected to a control signal output for indicating the second switch unit to be switched on or switched off.

17. A display apparatus, comprising the apparatus for transmitting data according to claim 12.

18. The display apparatus according to claim 17, wherein two adjacent rows of gate lines in the display apparatus form a group of gate lines, different groups of gate lines comprise different gate lines, and a first switch unit for controlling whether to conduct two rows of gate lines in each group of gate lines is arranged between the two rows of gate lines; and
two adjacent columns of data lines in the display apparatus form a group of data lines, different groups of data lines comprise different data lines, and a second switch unit for controlling whether to conduct two columns of data lines in each group of data lines is arranged between the two columns of data lines.

19. The display apparatus according to claim 18, wherein the first switch unit is a thin film transistor having a source and a drain respectively connected to two rows of gate lines in a group of gate lines where the thin film transistor is located, and a gate connected to a control signal output for indicating the first switch unit to be switched on or switched off; and
the second switch unit is a thin film transistor having a source and a drain respectively connected to two columns of data lines in a group of data lines where the thin film transistor is located, and a gate connected to a control signal output for indicating the second switch unit to be switched on or switched off.
